(19) United States
(12) Patent Application Publication
(10) Pub. No.: US 2025/0058565 A1
(43) Pub. Date: Feb. 20, 2025

(54) INKJET PRINTING APPARATUS

(71) Applicant: Samsung Display Co., LTD., Yongin-si (KR)

(72) Inventors: Lae Ho KIM, Yongin-si (KR); Yu KONTA, Yongin-si (KR); Cheong Wan MIN, Yongin-si (KR); Jae Bum PAHK, Yongin-si (KR); Min Woo LEE, Yongin-si (KR); Tae Ho LEE, Yongin-si (KR); Jai Hyuk CHOI, Yongin-si (KR); Myung Soo HUH, Yongin-si (KR)

(21) Appl. No.: 18/630,473

(22) Filed: Apr. 9, 2024

(30) Foreign Application Priority Data
Aug. 16, 2023 (KR) 10-2023-0107286

(51) Int. Cl. B41J 2/175; B41J 2/18

(52) U.S. Cl. CPC B41J 2/17596; B41J 2/18

(57) ABSTRACT

An inkjet printing apparatus includes: a plurality of inkjet heads configured to discharge ink, a supply storage device configured to supply the ink to the plurality of inkjet heads, a plurality of supply flow paths configured to move the ink from the supply storage device to the plurality of inkjet heads, a plurality of discharge flow paths configured to move the ink from the plurality of inkjet heads to the supply storage device, and a plurality of by-pass lines directly connecting the plurality of supply flow paths with the plurality of discharge flow paths.

This application claims priority to Korean Patent Application No. 10-2023-0107286,filed on Aug. 16, 2023, and all the benefits accruing therefrom under 35 U.S.C. § 119, the content of which in its entirety is herein incorporated by reference.

### BACKGROUND

### Technical Field

The present disclosure relates to an inkjet printing apparatus.

### Description of the Related Art

With the advancement of multimedia, importance of a display device has been increased. Examples of the display device include a liquid crystal display (“LCD”) device and organic light emitting display (“OLED”) device. Such display devices have been diversified in their application examples based on various mobile electronic devices, for example, portable electronic devices such as smart phones, smart watches and tablet PCs.

Meanwhile, in a display device such as an organic light emitting display device, an inkjet printing apparatus may be used to form an organic light emitting layer. The inkjet printing apparatus may perform a process of supplying a predetermined ink or solution to an inkjet head, wherein the inkjet head may perform a process of discharging the ink or solution onto a substrate (e.g., target substrate) to be processed while the substrate is reciprocating.

### SUMMARY

An aspect of the present disclosure is to provide an inkjet printing apparatus in which printing reliability is improved by regulating a flow rate for each inkjet head.

Another aspect of the present disclosure is to provide an inkjet printing apparatus in which a discharge defect is minimized by minimizing occurrence of bubbles in a supply circulation system.

The T aspects of the present disclosure are not limited to those mentioned above and additional aspects of the present disclosure, which are not mentioned herein, will be clearly understood by those skilled in the art from the following description of the present disclosure.

According to an aspect of the present disclosure, there is provided an inkjet printing apparatus including, a plurality of inkjet heads configured to discharge ink, a supply storage device configured to supply the ink to the plurality of inkjet heads, a plurality of supply flow paths configured to move the ink from the supply storage device to the plurality of inkjet heads, a plurality of discharge flow paths configured to move the ink from the plurality of inkjet heads to the supply storage device, and a plurality of by-pass lines directly connecting the plurality of supply flow paths with the plurality of discharge flow paths.

In an embodiment, the inkjet printing apparatus may further include a plurality of flow rate regulators disposed in the plurality of by-pass lines, and the plurality of flow rate regulators may be configured to regulate a flow rate of the ink moving along the plurality of by-pass lines.

In an embodiment, the inkjet printing apparatus may further include a plurality of valves disposed in the plurality of supply flow paths, and the plurality of valves may be configured to adjust a flow of the ink moving along the plurality of supply flow paths.

In an embodiment, the inkjet printing apparatus may further include a plurality of flow rate regulators disposed in the plurality of supply flow paths, and the plurality of flow rate regulators may be configured to regulate a flow rate of the ink moving along the plurality of supply flow paths.

In an embodiment, the inkjet printing apparatus may further include a plurality of valves disposed in the plurality of by-pass lines, and the plurality of valves may be configured to control whether the ink flows along the plurality of by-pass lines.

In an embodiment, the plurality of supply flow paths may include first to fifth supply flow paths, the first supply flow path may be connected to the supply storage device and diverged into the second supply flow path and the third supply flow path at a first divergence point, the second supply flow path may be connected to the first divergence point and a second divergence point and diverged into the fourth supply flow path and the fifth supply flow path at the second divergence point, and the fourth and fifth supply flow paths may each be connected to any one of the plurality of inkjet heads.

In an embodiment, the plurality of discharge flow paths may include first to fifth discharge flow paths, the first discharge flow path and the second discharge flow path may each be connected to any one of the plurality of inkjet heads and may be merged into the third discharge flow path at a first merging point, the third discharge flow path may be connected to the first merging point and a second merging point, and the third discharge flow path and the fourth discharge flow path may be merged into the fifth discharge flow path at the second merging point, and the fifth discharge flow path may be connected to the supply storage device.

In an embodiment, the plurality of by-pass lines may include at least one of a first by-pass line or a second by-pass line, the first by-pass line may connect the fourth supply flow path with the first discharge flow path, and the second by-pass line may connect the fifth supply flow path with the second discharge flow path.

In an embodiment, the plurality of by-pass lines may include a third by-pass line, and the third by-pass line may connect the second supply flow path with the third discharge flow path.

In an embodiment, the inkjet printing apparatus may further include a pump disposed in the plurality of supply flow paths, and the pump may be configured to provide a driving force so that the ink may move along the plurality of supply flow paths.

In an embodiment, the supply storage device may be provided as one or more, the pump may be provided as one or more, the number of the one or more supply storage devices and the number of the one or more pumps may each be smaller than the number of the plurality of inkjet heads.

In an embodiment, the plurality of inkjet heads may be connected to one supply storage device and one pump.

In an embodiment, the inkjet printing apparatus may further include a buffer storage device configured to supply the ink to the supply storage device.

In an embodiment, the inkjet printing apparatus may further include, a first buffer flow path configured to move the ink from the buffer storage device to the supply storage device, and a second buffer flow path configured to move the ink from the first buffer flow path to the buffer storage device.

In an embodiment, the inkjet printing apparatus may further include a plurality of manifolds disposed between the plurality of supply flow paths and the plurality of inkjet heads, and the plurality of manifolds may be configured to supply the ink to a plurality of nozzles included in the plurality of inkjet heads.

According to an aspect of the present disclosure, there is provided an inkjet printing apparatus including: first and second inkjet heads configured to discharge ink, a supply storage device configured to supply the ink to the first and second inkjet heads, first and second supply flow paths configured to move the ink from the supply storage device to the first and second inkjet heads, respectively, first and second discharge flow paths configured to move the ink from the first and second inkjet heads to the supply storage device, respectively, and a first by-pass line connecting the first supply flow path with the first discharge flow path and a second by-pass line connecting the second supply flow path with the second discharge flow path.

In an embodiment, the inkjet printing apparatus may further include first and second flow rate regulators disposed in the first and second by-pass lines, respectively, and the first and second flow rate regulators may be configured to regulate flow rates of the ink moving along the first and second by-pass lines, respectively.

In an embodiment, the inkjet printing apparatus may further include first and second flow rate regulators disposed in the first and second supply flow paths, respectively, and the first and second flow rate regulators are configured to regulate flow rates of the ink moving along the first and second supply flow paths, respectively.

In an embodiment, the inkjet printing apparatus may further include first and second pumps disposed in the first and second supply flow paths, respectively, and the first and second pumps may be configured to provide a driving force so that the ink move along the first and second supply flow paths.

In an embodiment, the supply storage device may be provided as one or more, the pump may be provided as one or more, the number of the one or more supply storage devices and the number of the one or more pumps may each be smaller than the number of the inkjet heads.

In the inkjet printing apparatus according to one embodiment, printing reliability may be improved by regulating a flow rate for each inkjet head.

In the inkjet printing apparatus according to one embodiment, a discharge defect may be minimized by minimizing occurrence of bubbles in a supply circulation system.

The effects according to the embodiments of the present disclosure are not limited to those mentioned above and more various effects are included in the following description of the present disclosure.

### BRIEF DESCRIPTION OF THE DRAWINGS

The above and other aspects and features of the present disclosure will become more apparent by describing in detail embodiments thereof with reference to the attached drawings, in which:

FIG. 1 is a plan view illustrating a display device according to one embodiment;

FIG. 2 is a cross-sectional view taken along line X1-X1′ of FIG. 1;

FIG. 3 is an enlarged view illustrating an area ‘A’ of FIG. 2;

FIG. 4 is a view illustrating an equivalent circuit of a circuit layer according to one embodiment;

FIG. 5 is a cross-sectional view illustrating an inkjet printing apparatus according to one embodiment;

FIG. 6 is a block diagram illustrating a circulation structure of an inkjet printing apparatus according to one embodiment;

FIG. 7 is an enlarged view illustrating an area ‘B’ of FIG. 5;

FIG. 8 is a cross-sectional view illustrating an inkjet printing apparatus according to another embodiment;

FIG. 9 is a block diagram illustrating a circulation structure of an inkjet printing apparatus according to another embodiment;

FIG. 10 is a cross-sectional view illustrating an inkjet printing apparatus according to still another embodiment;

FIG. 11 is a block diagram illustrating a circulation structure of an inkjet printing apparatus according to still another embodiment; and

FIG. 12 is an enlarged view illustrating an area ‘C’ of FIG. 10.

### DETAILED DESCRIPTION

The invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will filly convey the scope of the invention to those skilled in the art.

It will also be understood that when a layer is referred to as being “on” or “connected to” another element, another layer or substrate, it can be directly on or directly connected to the other layer or substrate, or intervening layers may also be present. The same reference numbers indicate the same components throughout the specification.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, embodiments of the present disclosure will be described in detail with reference to the accompanying drawings.

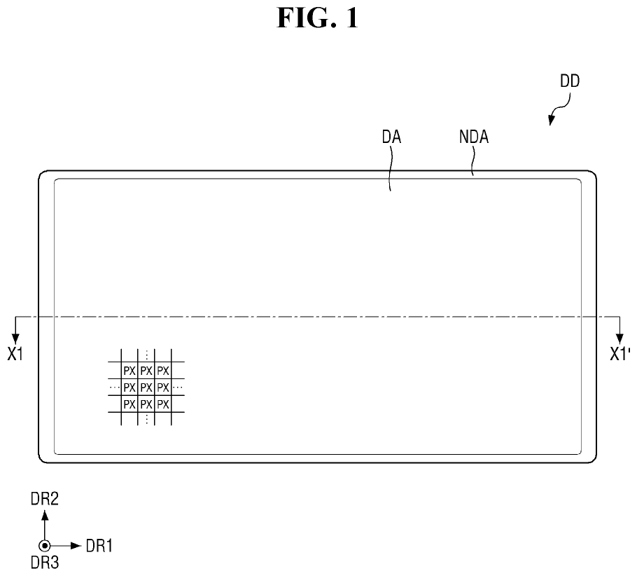

FIG. 1 is a plan view illustrating a display device according to one embodiment. As used herein, the plan view is a view in the third direction DR3.

Referring to FIG. 1, a display device DD may refer to all electronic devices that provide a display screen. The display device DD may display a moving image or a still image. For example, a television, a laptop computer, a monitor, an advertising board, an Internet of Things (“IoT”) device, a mobile phone, a smart phone, a tablet personal computer (“PC”), an electronic watch, a smart watch, a watch phone, a head mounted display, a mobile communication terminal, an electronic diary, an electronic book, a portable multimedia player (“PMP”), a navigator, a game machine, a digital camera, a camcorder and the like may be included in the display device DD.

In one embodiment, the display device DD may have a rectangular shape in a plan view. The display device DD may include two long sides extended in a first direction DR1 and two short sides extended in a second direction DR2 crossing the first direction DR1. A corner where the long side and the short side of the display device DD meet may be formed at a right angle, but is not limited thereto, and may be rounded to form a curved surface in another embodiment. In another embodiment, the long side may be extended in the second direction DR2, and the short side may be extended in the first direction DR1. The planar shape of the display device DD is not limited to the illustrated example, and may have a circular shape or other shape.

In the shown drawing, the first direction DR1 and the second direction DR2 are horizontal directions and cross each other. For example, the first direction DR1 and the second direction DR2 may be orthogonal to each other. Also, a third direction DR3 crosses the first direction DR1 and the second direction DR2, and for example, may be a vertical direction orthogonal to the first direction DR1 and the second direction DR2. Unless otherwise defined, in the present disclosure, a direction indicated by an arrow in the first to third directions DR1, DR2 and DR3 may be referred to as one side, and its opposite direction may be referred to as the other side.

The display device DD includes a display panel for providing a display screen. Examples of the display panel may include an inorganic light emitting diode display panel, an organic light emitting display panel, a quantum dot light emitting display panel, a plasma display panel and a field emission display panel. Hereinafter, an organic light emitting diode display panel is applied as an example of the display panel, but the example of the display panel is not limited to the organic light emitting diode display panel, and another display panel may be applied when the same technical spirits are applicable thereto.

The display device DD may include a display area DA and a non-display area NDA disposed in the vicinity of the display area DA. The display area DA is an area in which a screen is displayed, and the non-display area NDA is an area in which a screen is not displayed. The display area DA may be referred to as an active area, and the non-display area NDA may be referred to as a non-active area. The display area DA may generally occupy the center of the display device DD, and the non-display area NDA may be disposed to surround the display area DA.

The display area DA may include a plurality of pixels PX. The plurality of pixels PX may be arranged in a matrix direction. A shape of each pixel PX may be a rectangular or square shape in a plan view, but is not limited thereto. The shape of each pixel PX may be a rhombus shape in which each side is inclined with respect to one direction in another embodiment.

As described above, the non-display area NDA may be disposed in the vicinity of the display area DA. The non-display area NDA may fully or partially surround the display area DA. The display area DA may be rectangular in shape, and the non-display area NDA may be disposed to be adjacent to four sides of the display area DA. The non-display area NDA may constitute a bezel of the display device DD. Lines or circuit drivers included in the display device DD may be disposed in each of the non-display areas NDA, or external devices may be packaged therein.

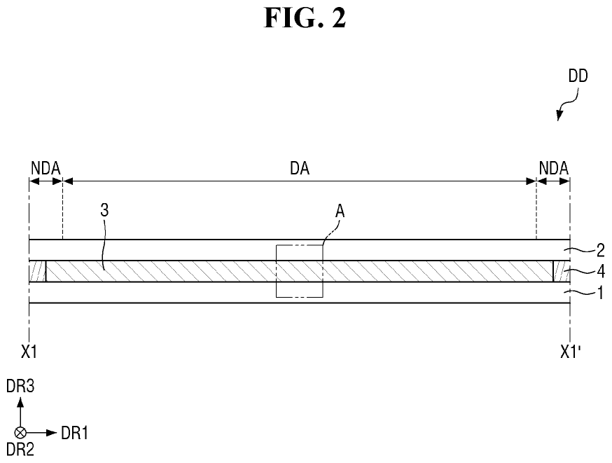

FIG. 2 is a cross-sectional view taken along line X1-X1′ of FIG. 1.

Referring to FIG. 2, the display device DD includes a display substrate 1 and a color conversion substrate 2 opposite to the display substrate 1, and may further include a scaling portion 4 for coupling the display substrate 1 and the color conversion substrate 2 to each other, and a filler 3 filled between the display substrate 1 and the color conversion substrate 2.

The display substrate 1 may include elements and circuits for displaying an image, for example, a pixel circuit such as a switching element, a pixel defining layer for defining a light emission area and a non-light emission area, and a self-light emitting clement. In one embodiment, the self-light emitting element may include at least one of an organic light emitting diode, a quantum dot light emitting diode, an inorganic-based micro light emitting diode (e.g., micro LED) or an inorganic-based nano light emitting diode (e.g., nano LED).

The color conversion substrate 2 may be positioned on the display substrate 1 and face the display substrate 1. In one embodiment, the color conversion substrate 2 may include a color conversion pattern for converting a color of incident light. In one embodiment, the color conversion pattern may include at least one of a color filter or a wavelength conversion pattern.

The scaling portion 4 may be positioned between the display substrate 1 and the color conversion substrate 2 in the non-display area NDA. The sealing portion 4 may be disposed along the edge of the display substrate 1 and the color conversion substrate 2 in the non-display area NDA to surround the display area DA in a plan view. The display substrate 1 and the color conversion substrate 2 may be coupled to each other by means of the sealing portion 4.

The filler 3 may be positioned in a space between the display substrate 1 and the color conversion substrate 2, which is surrounded by the sealing portion 4. The filler 3 may fill the space between the display substrate 1 and the color conversion substrate 2. The filler 3 may be made of a material capable of transmitting light. In some embodiments, the filler 3 may be omitted.

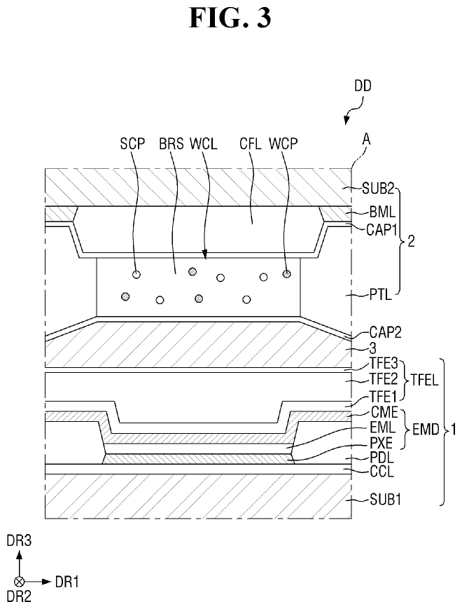

FIG. 3 is an enlarged view illustrating an area ‘A’ of FIG. 2.

Referring to FIG. 3, the display device DD may include a display substrate 1, a color conversion substrate 2 opposite to the display substrate 1, and a filler 3 coupling the display substrate 1 and the color conversion substrate 2 to each other.

The display substrate I may include a first base substrate SUB 1, a light emitting element EMD and a thin film encapsulation layer TFEL.

The first base substrate SUB1 may include a transparent material. In an embodiment, for example, the first base substrate SUB1 may include a transparent insulating material such as glass and quartz. The first base substrate SUB1 may be a rigid substrate, but is not limited thereto, and may include plastic such as polyimide or have flexible properties capable of being curved, bent, folded or rolled in another embodiment.

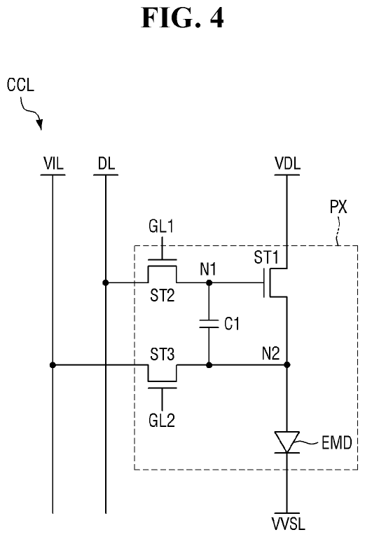

A circuit layer CCL may be disposed on the first base substrate SUB1. The circuit layer CCL may include a transistor and various circuit lines to drive the light emitting element EMD. The circuit layer CCL may be disposed between the first base substrate SUB1 and the light emitting element EMD. The circuit layer CCL will be described later with reference to FIG. 4.

The light emitting clement EMD may be disposed on the circuit layer CCL. Although one light emitting element EMD is shown in FIG. 2 by illustrating one pixel PX by way of example, the display substrate 1 may include a plurality of light emitting elements EMD disposed for respective pixels PX, respectively.

The light emitting element EMD may include a pixel electrode PXE, a pixel defining layer PDL, a light emitting layer EML and a common electrode CME.

The pixel electrode PXE may be disposed on the circuit layer CCL of the display substrate 1. The pixel electrode PXE may be a first electrode of the light emitting element EMD, for example, an anode electrode. The pixel electrode PXE may have a stacked layer structure in which a material layer, which has a high work function, such as indium-tin-oxide (“ITO”), indium-zinc-oxide (“IZO”), zinc oxide (ZnO) and indium oxide (In₂O₃), and a reflective material layer such as Ag, Mg, Al, Pt, Pd, Au, Ni, Nd, Ir, Cr, Li, Ca or their mixture are stacked. The material layer having a high work function may be disposed above the reflective material layer, whereby the material layer may be close to the light emitting layer EML. The pixel electrode PXE may have a multi-layered structure of ITO/Mg, ITO/MgF, ITO/Ag and ITO/Ag/ITO, but is not limited thereto.

The pixel defining layer PDL may be disposed on the pixel electrode PXE along a boundary of the pixel PX. The pixel defining layer PDL may include an opening that exposes at least a portion of the pixel electrode PXE. A light emission area and a non-light emission area may be distinguished by the pixel defining layer PDL and its opening.

The pixel defining layer PDL may include an organic insulating material such as a polyacrylates resin, an epoxy resin, a phenolic resin, a polyamides resin, a polyimides resin, an unsaturated polyesters resin, a poly phenylene ethers resin, a polyphenylene sulfides resin or benzocyclobutene (“BCB”). The pixel defining layer PDL may include an inorganic material.

The light emitting layer EML may be disposed on the pixel electrode PXE exposed by the pixel defining layer PDL. In one embodiment in which the display device DD is an organic light emitting display device, the light emitting layer EML may include an organic layer that includes an organic material. The organic layer includes an organic light emitting layer, and may further include at least one of a hole injection layer, a hole transporting layer, an electron transporting layer or an electron injection layer as an auxiliary layer for assisting light emission. In another embodiment, when the display device DD is a micro LED display device, a nano LED display device or the like, the light emitting layer EML may include an inorganic material such as an inorganic semiconductor.

In one embodiment, a wavelength of light emitted by each light emitting layer EML may be the same for each pixel PX. In an embodiment, for example, the light emitting layer EML of each pixel PX emits blue light or ultraviolet rays and the color conversion substrate 2, which will be described later, includes a wavelength conversion layer WCL, whereby a color for each pixel PX may be displayed. In another embodiment, the wavelength of light emitted by each light emitting layer EML may be different for each pixel PX.

The common electrode CME may be disposed on the light emitting layer EML. The common electrode CME may be connected without distinction of each pixel PX. The common electrode CME may be a front electrode disposed on entire pixels PX without distinction of the pixels PX. The common electrode CME may be a second electrode of the light emitting element EMD, for example, a cathode electrode. The common electrode CME may include a material layer having a small work function, such as Li, Ca, LiF/Ca, LiF/Al, Al, Mg, Ag, Pt, Pd, Ni, Au Nd, Ir, Cr, BaF, Ba or their compound or mixture (e.g., a mixture of Ag and Mg). The common electrode CME may further include a transparent metal oxide layer disposed on the material layer having a small work function.

The thin film encapsulation layer TFEL may be disposed on the common electrode CME. The thin film encapsulation layer TFEL may include a first inorganic layer TFE1, an organic layer TFE2 and a second inorganic layer TFE3.

The first inorganic layer TFE1 may be disposed on the light emitting element EMD. The first inorganic layer TFE1 may include a silicon nitride (SiNₓ), a silicon oxide (SiOₓ), or a silicon oxynitride (SiOₓN_{y}).

The organic layer TFE2 may be disposed on the first inorganic layer TFE1. The organic layer TFE2 may include an organic insulating material such as a polyacrylates resin, an epoxy resin, a phenolic resin, a polyamides resin, a polyimides resin, an unsaturated polyesters resin, a poly phenylene ethers resin, a polyphenylene sulfides resin or benzocyclobutene (BCB).

The second inorganic layer TFE3 may be disposed on the organic layer TFE2. The second inorganic layer TFE3 may include the same material as a material of the above-described first inorganic layer TFE1. In an embodiment, for example, the second inorganic layer TFE3 may include a silicon nitride (SiNₓ), a silicon oxide (SiOₓ) or a silicon oxynitride (SiOₓN_{y}).

The color conversion substrate 2 may be disposed above the thin film encapsulation layer TEFL to face the display substrate 1. In detail, the color conversion substrate 2 may be disposed to face the display substrate 1 with the filler 3 interposed therebetween.

The color conversion substrate 2 may include a second base substrate SUB2, a light blocking member BML, a color filter layer CFL, a first capping layer CAP1, a partition wall PTL, a wavelength conversion layer WCL and a second capping layer CAP2.

The second base substrate SUB2 may include a transparent material. In an embodiment, for example, the second base substrate SUB2 may include a transparent insulating material such as glass and quartz. The second base substrate SUB2 may be a rigid substrate, but is not limited thereto, and may include plastic such as polyimide or have flexible properties capable of being curved, bent, folded or rolled in another embodiment.

The second base substrate SUB2 may be the same substrate as the first base substrate SUB1, but its material, thickness, light transmittance, etc. may be different from those of the first base substrate SUB1. In an embodiment, for example, the second base substrate SUB2 may have light transmittance higher than light transmittance of the first base substrate SUB1. The second base substrate SUB2 may be thicker or thinner than the first base substrate SUB1.

The light blocking member BML may be disposed on one surface of the second base substrate SUB2, which is directed toward the first base substrate SUB1, along the boundary of the pixel PX. The light blocking member BML may overlap the pixel defining layer PDL of the display substrate 1 in a plan view. The light blocking member BML includes an opening that exposes one surface of the second base substrate SUB2, and although not shown, the light blocking member BML may have a grid shape on a plan view.

The light blocking member BML may include an organic material. The light blocking member BML may reduce color distortion due to reflection of external light by absorbing the external light. In addition, the light blocking member BML may serve to prevent light emitted from the light emitting layer EML from being permeated into an adjacent pixel PX.

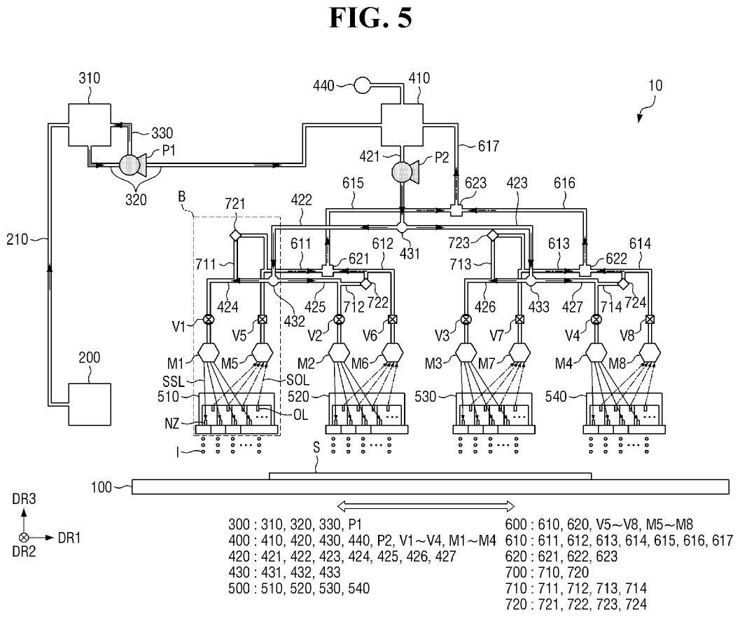

The color filter layer CFL may be disposed on one surface of the second base substrate SUB2 on which the light blocking member BML is disposed. The color filter layer CFL may be disposed on one surface of the second base substrate SUB2 exposed through the opening of the light blocking member BML. In some embodiments, the color filter layer CFL may be formed using an inkjet printing apparatus 10 (see FIG. 5) that will be described later.

The color filter layer CFL may include a colorant such as a dye or a pigment, which absorbs light of a wavelength band other than a corresponding color wavelength. The color filter layer CFL may include colorants of different colors for each pixel PX. In an embodiment, for example, the color filter layer CFL may include a red colorant, a green colorant and a blue colorant.

The first capping layer CAP1 may be disposed on the color filter layer CFL. The first capping layer CAP1 may prevent permeation of impurities such as moisture or air. In addition, the first capping layer CAP1 may prevent the colorant of the color filter layer CFL from being diffused to another element.

The partition wall PTL may be disposed on the first capping layer CAP1. The partition wall PTL may be disposed to overlap the light blocking member BML in a plan view. The partition wall PTL may include an opening that exposes an area in which the color filter layer CFL is disposed. The partition wall PTL may include a photosensitive organic material, but is not limited thereto. The partition wall PTL may further include a light blocking material.

The wavelength conversion layer WCL may be disposed in a space through which the opening of the partition wall PTL is exposed. In some embodiments, the wavelength conversion layer WCL may be formed using the inkjet printing apparatus 10 (see FIG. 5) that will be described later.

The wavelength conversion layer WCL may convert a wavelength of light incident from the light emitting layer EML. The wavelength conversion layer WCL may include a base resin BRS, a scatterer SCP disposed in the base resin BRS, and a wavelength conversion material WCP.

The base resin BRS may include a light-transmissive organic material. In an embodiment, for example, the base resin BRS may include an epoxy-based resin, an acryl-based resin, a cardo-based resin, an imide-based resin, or the like.

The wavelength conversion material WCP may be a material that converts color. The wavelength conversion material WCP may be a quantum dot, a quantum rod, a phosphor or the like. The quantum dot may include group-IV nano-crystal, group II-VI compound nano-crystal, group III-V compound nano-crystal, group IV-VI nano-crystal or their combination.

In another embodiment, the wavelength conversion layer WCL may not include a wavelength conversion material WCP. When the wavelength conversion layer WCL does not include the wavelength conversion material WCP, the wavelength conversion layer WCL may serve as a light transmitting layer for transmitting light.

The scatterer SCP may be a metal oxide particle or an organic particle. An example of the metal oxide particle may include a titanium oxide (TiO₂), a zirconium oxide (ZrO₂), an aluminum oxide (Al₂O₃), an indium oxide (In₂O₃), a zinc oxide (ZnO) or a tin oxide (SnO₂), and an example of the organic particle may include an acryl-based resin or a urethane-based resin.

The second capping layer CAP2 may be disposed on the wavelength conversion layer WCL and the partition wall PTL. The second capping layer CAP2 may be disposed on a front surface of the color conversion substrate 2. The second capping layer CAP2 may prevent permeation of impurities such as moisture or air. The second capping layer CAP2 may be made of an inorganic material. The second capping layer CAP2 may include a material selected from the materials listed as a material of the first capping layer CAP1. The second capping layer CAP2 and the first capping layer CAP1 may be formed of or include the same material, but are not limited thereto.

The filler 3 may be disposed between the display substrate 1 and the color conversion substrate 2. The filler 3 may fill a space between the display substrate 1 and the color conversion substrate 2 and serve to couple the display substrate 1 and the color conversion substrate 2 to each other. The filler 3 may be disposed between the thin film encapsulation layer TFEL of the display substrate 1 and the second capping layer CAP2 of the color conversion substrate 2. The filler 3 may be made of an Si-based organic material, an epoxy-based organic material or the like, but is not limited thereto.

FIG. 4 is a view illustrating an equivalent circuit of a circuit layer according to one embodiment.

Referring to FIG. 4, the circuit layer CCL may include various lines for driving the light emitting element EMD. In one embodiment, the circuit layer CCL may include a pixel circuit, a first voltage line VDL, an initialization voltage line VIL, a first gate line GL1, a second gate line GL2, a data line DL and a second voltage line VSL, which are included in each pixel PX.

The pixel PX may include a pixel circuit and a light emitting element EMD. The pixel circuit may be connected to the first voltage line VDL, the initialization voltage line VIL, the first gate line GL1, the second gate line GL2, the data line DL and the second voltage line VSL.

The first voltage line VDL may supply a driving voltage or a high potential voltage to the pixel circuit. The initialization voltage line VIL may supply an initialization voltage to the pixel circuit. The initialization voltage line VIL may receive a sensing signal from the pixel circuit. The second voltage line VSL may supply a low potential voltage to the light emitting element EMD. The first gate line GL1 may supply a first gate signal to the pixel circuit. The second gate line GL2 may supply a second gate signal to the pixel circuit. The data line DL may supply a data voltage to the pixel circuit.

The pixel circuit may include a first transistor ST1, a second transistor ST2, a third transistor ST3 and a first capacitor C1.

The first transistor ST1 may include a gate electrode, a drain electrode and a source electrode. The gate electrode of the first transistor ST1 may be connected to a first node N1, a drain electrode of the first transistor ST1 may be connected to a first voltage line VDL, and a source electrode of the first transistor ST1 may be connected to a second node N2. The first transistor ST1 may control a drain-source current (or driving current) based on the data voltage applied to the gate electrode. The first transistor ST1 may be a driving transistor for driving the light emitting element EMD.

The light emitting element EMD may emit light by receiving a driving current. The light emission amount or luminance of the light emitting element EMD may be proportional to a magnitude of the driving current. The light emitting element EMD may be an organic light emitting diode including an organic light emitting layer, a quantum dot light emitting element including a quantum dot light emitting layer, a micro light emitting diode (micro LED) or an inorganic light emitting diode (inorganic LED) including an inorganic semiconductor.

A first electrode of the light emitting element EMD may be connected to the second node N2, and a second electrode of the light emitting element EMD may be connected to the second voltage line VSL. The first electrode of the light emitting element EMD may be connected to the source electrode of the first transistor ST1, a drain electrode of the third transistor ST3 and a second capacitor electrode of the first capacitor C1 through the second node N2.

The second transistor ST2 may be turned on by the first gate signal of the first gate line GL1 to electrically connect the data line DL with the first node N1 that is the gate electrode of the first transistor ST1. The second transistor ST2 may be turned on based on the first gate signal, thereby supplying the data voltage to the first node N1. A gate electrode of the second transistor ST2 may be connected to the first gate line GL1, a drain electrode of the second transistor ST2 may be connected to the data line DL, and a source electrode of the second transistor ST2 may be connected to the first node N1. The source electrode of the second transistor ST2 may be connected to the gate electrode of the first transistor ST1 and the first capacitor electrode of the first capacitor C1 through the first node N1. The second transistor ST2 may be a switching transistor that controls a current flowing to the first transistor ST1 and the light emitting element EMD.

The third transistor ST3 may be turned on by the second gate signal of the second gate line GL2 to electrically connect the initialization voltage line VIL with the second node N2 that is the source electrode of the first transistor ST1. The third transistor ST3 may be turned on based on the second gate signal to supply the initialization voltage to the second node N2. The third transistor ST3 may be turned on based on the second gate signal to supply the sensing signal to the initialization voltage line VIL. A gate electrode of the third transistor ST3 may be connected to the second gate line GL2, the drain electrode of the third transistor ST3 may be connected to the second node N2, and the source electrode of the third transistor ST3 may be connected to the initialization voltage line VIL. The drain electrode of the third transistor ST3 may be connected to the source electrode of the first transistor ST1, the second capacitor electrode of the first capacitor C1 and the first electrode of the light emitting element EMD through the second node N2. The third transistor ST3 may be a switching transistor that controls a current flowing to the first transistor ST1 and the light emitting element EMD.

The first capacitor C1 may include a first capacitor electrode and a second capacitor electrode. The first capacitor electrode may be connected to the gate electrode of the first transistor ST1 and the source electrode of the second transistor ST2 through the first node N1. The second capacitor electrode may be connected to the source electrode of the first transistor ST1 and the first electrode of the light emitting element EMD through the second node N2. The second capacitor electrode may be connected to the drain electrode of the third transistor ST3. The first capacitor C1 may store capacitance by using a voltage difference between the first capacitor electrode and the second capacitor electrode.

In an embodiment, for example, the layers such as the light emitting layer EML, the color filter layer CFL and the wavelength conversion layer WCL among various patterns of the display device DD may be formed by using the inkjet printing apparatus. Hereinafter, the inkjet printing apparatus used to form the patterns will be described.

FIG. 5 is a cross-sectional view illustrating an inkjet printing apparatus according to one embodiment.

Referring to FIG. 5, an inkjet printing apparatus 10 may include a stage 100, an ink supply device 200, a buffer circulation system 300, a supply circulation system 400, an inkjet head 500, a discharge circulation system 600 and a uniform circulation system 700.

The stage 100 may provide a space on which a target substrate S is seated. In this case, the target substrate S may be the above-described display device DD (see FIG. 1). The stage 100 may have a flat panel shape. A planar shape of the stage 100 may be similar to a shape of the target substrate S. In an embodiment, for example, the planar shape of the stage 100 may be approximately rectangular, but is not limited thereto in a plan view.

In some embodiments, the stage 100 may move in the first direction DR1 and/or the second direction DR2. Although not shown in the drawing, the stage 100 may further include a separate driver for providing a driving force to the stage 100.

The ink supply device 200 may store ink I and provide the stored ink I to the buffer circulation system 300. The ink I may include a solvent made of a polymer material or water and ink particles dispersed in the solvent. The solvent and the ink particles may include different materials depending on an element of the display device DD (see FIG. 1), which is to be printed.

The T ink supply device 200 may further include an initial supply flow path 210. The initial supply flow path 210 may connect the ink supply device 200 with the buffer circulation system 300. The ink I of the ink supply device 200 may move to the buffer circulation system 300 through the initial supply flow path 210.

The buffer circulation system 300 may be a circulation system for a buffer for preventing ink particles of the ink I from being precipitated in the inkjet printing apparatus 10 and removing bubbles generated inside the ink I.

The buffer circulation system 300 may include a buffer storage device 310, a first buffer flow path 320, a second buffer flow path 330 and a first pump P1.

The buffer storage device 310 may temporarily store the ink I before the ink I of the ink supply device 200 moves to the supply circulation system 400.

The first buffer flow path 320 may connect the buffer storage device 310 with the supply circulation system 400. At least a portion of the ink I of the buffer storage device 310 may move to the supply circulation system 400 through the first buffer flow path 320.

The second buffer flow path 330 may connect the first buffer flow path 320 with the buffer storage device 310. At least a portion of the ink I of the first buffer flow path 320 may return to the buffer storage device 310 through the second buffer flow path 330. Therefore, a negative pressure of the supply circulation system 400 and a flow rate of the ink I in the supply circulation system 400 may be uniformly maintained. In addition, even though the ink I is not discharged for a long time, the ink I may be continuously circulated so that ink particles may be prevented from being precipitated in the buffer circulation system 300.

The first pump P1 may provide a driving force so that a portion of the ink I stored in the buffer storage device 310 may move to the supply circulation system 400 through the first buffer flow path 320. In addition, the first pump P1 may provide a driving force so that a portion of the ink I moving along the first buffer flow path 320 may move back to the buffer storage device 310. In an embodiment, for example, the first pump P1 may be a fluid pump that transfers a power to a fluid such as the ink I.

The supply circulation system 400 may be a supply circulation system for supplying the ink I to the inkjet head 500 in the inkjet printing apparatus 10 such as providing a negative pressure.

The supply circulation system 400 may include a supply storage device 410, a supply flow path 420, a divergence point 430, a pressure regulator 440, a second pump P2, a plurality of supply valves V1, V2, V3 and V4, and a plurality of supply manifolds M1, M2, M3 and M4.

The supply storage device 410 may store the ink I before the ink I of the buffer storage device 310 moves to the inkjet head 500.

The supply flow path 420 may include a plurality of supply flow paths 421, 422, 423, 424, 425, 426 and 427. The divergence point 430 may include a plurality of divergence points 431, 432 and 433. In an embodiment, for example, the supply flow path 420 may include a first supply flow path 421, a second supply flow path 422, a third supply flow path 423, a fourth supply flow path 424, a fifth supply flow path 425, a sixth supply flow path 426 and a seventh supply flow path 427. The divergence point 430 may include a first divergence point 431, a second divergence point 432 and a third divergence point 433. However, the number of the supply flow paths 420 and the number of the divergence points 430 are not limited to the above example, and various modifications may be made in the number of the supply flow paths 420 and the number of the divergence points 430 depending on the number of the inkjet heads 500 and a design structure of the inkjet printing apparatus 10.

The first supply flow path 421 may connect the supply storage device 410 with the first divergence point 431. The first divergence point 431 may be a divergence point where the first supply flow path 421 is diverged to the second supply flow path 422 and the third supply flow path 423.

The second supply flow path 422 may connect the first divergence point 431 with the second divergence point 432. The second divergence point 432 may be a divergence point where the second supply flow path 422 is diverged to the fourth supply flow path 424 and the fifth supply flow path 425. The third supply flow path 423 may connect the first divergence point 431 with the third divergence point 433. The third divergence point 433 may be a divergence point where the third supply flow path 423 is diverged to the sixth supply flow path 426 and the seventh supply flow path 427.

The fourth supply flow path 424 may connect the second divergence point 432 with a first manifold M1. The fifth supply flow path 425 may connect the second divergence point 432 with a second manifold M2. The sixth supply flow path 426 may connect a third divergence point 433 with a third manifold M3. The seventh supply flow path 427 may connect the third divergence point 433 with a fourth manifold M4. The fourth supply flow path 424, the fifth supply flow path 425, the sixth supply flow path 426 and the seventh supply flow path 427 may supply the ink I to the first inkjet head 510, the second inkjet head 520, the third inkjet head 530 and the fourth inkjet head 540, respectively.

The pressure regulator 440 may provide a negative pressure to the supply circulation system 400. In an embodiment, for example, the pressure regulator 440 may be a vacuum regulator or an air regulator. The pressure regulator 440 may provide a negative pressure to the supply circulation system 400 so that the ink I positioned at a nozzle NZ of the inkjet head 500 forms a meniscus. In addition, the ink I positioned at the nozzle NZ of the inkjet head 500 may be prevented from being randomly discharged by gravity.

The second pump P2 may provide a driving force so that the ink I stored in the supply storage device 410 may move to the inkjet head 500 through the supply flow path 420. In an embodiment, for example, the second pump P2 may be a fluid pump that transfers a power to a fluid such as the ink I.

The plurality of supply valves V1, V2, V3 and V4 may adjust whether the ink I flows in the supply flow path 420. In one embodiment, the plurality of supply valves V1, V2, V3 and V4 may be on/off valves. In an embodiment, for example, when the plurality of supply valves V1, V2, V3 and V4 are opened, the ink I may pass through the supply flow path 420, and when the plurality of supply valves V1, V2, V3 and V4 are closed, the ink I may not pass through the supply flow path 420.

In one embodiment, the plurality of supply valves V1, V2, V3 and V4 may include a first valve V1, a second valve V2, a third valve V3 and a fourth valve V4. The first valve V1 may be disposed in the fourth supply flow path 424 to adjust whether the ink I flows in the fourth supply flow path 424. The second valve V2 may be disposed in the fifth supply flow path 425 to adjust whether the ink I flows in the fifth supply flow path 425. The third valve V3 may be disposed in the sixth supply flow path 426 to adjust whether the ink I flows in the sixth supply flow path 426. The fourth valve V4 may be disposed in the seventh supply flow path 427 to adjust whether the ink I flows in the seventh supply flow path 427. However, the number of the supply valves V1, V2, V3 and V4 is not limited to the above example, and various modifications may be made in the number of the supply valves V1, V2, V3 and V4 depending on the number of the inkjet heads 500 and the design structure of the inkjet printing apparatus 10.

The plurality of supply manifolds M1, M2, M3 and M4 may supply the ink I to each nozzle NZ of the inkjet head 500. In an embodiment, for example, the plurality of supply manifolds M1, M2, M3 and M4 may diverge the supply flow path 420 into a plurality of sub-supply flow paths SSL connected to the plurality of nozzles NZ.

In one embodiment, the plurality of supply manifolds M1, M2, M3 and M4 may include a first manifold M1, a second manifold M2, a third manifold M3 and a fourth manifold M4. The first manifold M1 may be connected to the fourth supply flow path 424 to supply the ink to a plurality of nozzles NZ of the first inkjet head 510. The second manifold M2 may be connected to the fifth supply flow path 425 to supply the ink to a plurality of nozzles NZ of the second inkjet head 520. The third manifold M3 may be connected to the sixth supply flow path 426 to supply the ink to a plurality of nozzles NZ of the third inkjet head 530. The fourth manifold M4 may be connected to the seventh supply flow path 427 to supply the ink to a plurality of nozzles NZ of the fourth inkjet head 540. However, the number of the supply manifolds M1, M2, M3 and M4 is not limited to the above example, and various modifications may be made in the number of the supply manifolds M1, M2, M3 and M4 depending on the number of the inkjet heads 500 and the design structure of the inkjet printing apparatus 10.

The inkjet head 500 may be disposed on the stage 100. The inkjet head 500 may discharge the ink I toward the stage 100. The inkjet head 500 may be disposed on the stage 100. The ink I discharged from the inkjet head 500 may be seated on the target substrate S disposed on the stage 100.

The inkjet head 500 may include a plurality of nozzles NZ and a plurality of outlets OL.

The plurality of nozzles NZ may face the stage 100. The plurality of nozzles NZ may be connected to the supply manifolds M1, M2, M3 and M4, respectively. The ink I supplied from the supply manifolds M1, M2, M3 and M4 may be discharged through the plurality of nozzles NZ.

The plurality of outlets OL may be connected to discharge manifolds M5, M6, M7 and M8, respectively. The ink I remaining in the inkjet head 500 without being discharged through the plurality of nozzles NZ may move to the discharge manifolds M5, M6, M7 and M8 through the plurality of outlets OL.

In one embodiment, the inkjet head 500 may include a first inkjet head 510, a second inkjet head 520, a third inkjet head 530 and a fourth inkjet head 540. The first inkjet head 510, the second inkjet head 520, the third inkjet head 530 and the fourth inkjet head 540 may be disposed along the first direction DR1 or the second direction DR2. As shown in the drawing, the first inkjet head 510, the second inkjet head 520, the third inkjet head 530 and the fourth inkjet head 540 may be spaced apart from one another, but are not limited thereto. Although it has been described that the number of the inkjet heads 500 is four, the number of the inkjet heads 500 is not limited thereto and may be modified.

The discharge circulation system 600 may be a discharge circulation system for reusing the ink I remaining in the inkjet head 500 without being discharged through the nozzle NZ

The discharge circulation system 600 may include a discharge flow path 610, a merging point 620, a plurality of discharge valves V5, V6, V7 and V8 and a plurality of discharge manifolds M5, M6, M7 and M8.

The plurality of discharge manifolds M5, M6, M7 and M8 may discharge the ink I from each outlet OL of the inkjet head 500. In an embodiment, for example, the plurality of discharge manifolds M5, M6, M7 and M8 may merge a plurality of sub-discharge flow paths SOL, which are connected to the plurality of outlets OL, into the discharge flow path 610.

In one embodiment, the plurality of discharge manifolds M5, M6, M7 and M8 may include a fifth manifold M5, a sixth manifold M6, a seventh manifold M7 and an eighth manifold M8. The fifth manifold M5 may be connected to a first discharge flow path 611 to discharge the ink I from the plurality of outlets OL of the first inkjet head 510. The sixth manifold M6 may be connected to a second discharge flow path 612 to discharge the ink I from the plurality of outlets OL of the second inkjet head 520. The seventh manifold M7 may be connected to a third discharge flow path 613 to discharge the ink I from the plurality of outlets OL of the third inkjet head 530. The eighth manifold M8 may be connected to a fourth discharge flow path 614 to discharge the ink I from the plurality of outlets OL of the fourth inkjet head 540. However, the number of discharge manifolds M5, M6, M7 and M8 is not limited to the above example, and various modifications may be made in the number of discharge manifolds M5, M6, M7 and M8 depending on the number of inkjet heads 500 and the design structure of inkjet printing apparatus 10.

The discharge flow path 610 may include a plurality of discharge flow paths 611, 612, 613, 614, 615, 616 and 617. The merging point 620 may include a plurality of merging points 621, 622 and 623. In an embodiment, for example, the discharge flow path 610 may include a first discharge flow path 611, a second discharge flow path 612, a third discharge flow path 613, a fourth discharge flow path 614, a fifth discharge flow path 615, a sixth discharge flow path 616 and a seventh discharge flow path 617. The merging point 620 may include a first merging point 621, a second merging point 622 and a third merging point 623. However, the number of the discharge flow paths 610 and the number of the merging points 620 are not limited to the above example, and various modifications may be made in the number of the discharge flow paths 610 and the number of the merging points 620 depending on the number of inkjet heads 500 and the design structure of the inkjet printing apparatus 10.

The first discharge flow path 611 may connect the first merging point 621 with the fifth manifold M5. The second discharge flow path 612 may connect the first merging point 621 with the sixth manifold M6. The first merging point 621 may be a merging point where the first discharge flow path 611 and the second discharge flow path 612 are merged into the fifth discharge flow path 615.

The third discharge flow path 613 may connect the second merging point 622 with the seventh manifold M7. The fourth discharge flow path 614 may connect the second merging point 622 with the eighth manifold M8. The second merging point 622 may be a merging point where the third discharge flow path 613 and the fourth discharge flow path 614 are merged into the sixth discharge flow path 616.

The fifth discharge flow path 615 may connect the first merging point 621 with the third merging point 623. The sixth discharge flow path 616 may connect the second merging point 622 with the third merging point 623. The third merging point 623 may be a merging point where the fifth discharge flow path 615 and the sixth discharge flow path 616 are merged into the seventh discharge flow path 617.

The seventh discharge flow path 617 may connect the third merging point 623 with the supply storage device 410. The seventh discharge flow path 617 may resupply the ink I to the supply storage device 410, so that the undischarged ink I may be reused.

The plurality of discharge valves V5, V6, V7 and V8 may adjust whether the ink I flows in the discharge flow path 610. In one embodiment, the plurality of discharge valves V5, V6, V7 and V8 may be on/off valves. In an embodiment, for example, when the plurality of discharge valves V5, V6, V7 and V8 are opened, the ink I may pass through the discharge flow path 610, and when the plurality of discharge valves V5, V6, V7 and V8 are closed, the ink I may not pass through the discharge flow path 610.

In one embodiment, the plurality of discharge valves V5, V6, V7 and V8 may include a fifth valve V5, a sixth valve V6, a seventh valve V7 and an eighth valve V8. The fifth valve V5 may be disposed in the first discharge flow path 611 to adjust whether the ink I flows in the first discharge flow path 611. The sixth valve V6 may be disposed in the second discharge flow path 612 to adjust whether the ink I flows in the second discharge flow path 612. The seventh valve V7 may be disposed in the third discharge flow path 613 to adjust whether the ink I flows in the third discharge flow path 613. The eighth valve V8 may be disposed in the fourth discharge flow path 614 to adjust whether the ink I flows in the fourth discharge flow path 614. However, the number of the discharge valves V5, V6, V7 and V8 is not limited to the above example, and various modifications may be made in the number of the discharge valves V5, V6, V7 and V8 depending on the number of the inkjet heads 500 and the design structure of the inkjet printing apparatus 10.

In the discharge circulation system 600, the ink I may be moved by the driving force of the supply circulation system 400. In an embodiment, for example, the ink I may circulate the supply circulation system 400, the inkjet head 500 and the discharge circulation system 600 by the driving force of the second pump P2 of the supply circulation system 400.

The uniform circulation system 700 may control distribution of the flow rate for each inkjet head 500 and remove bubbles BUB generated in the supply circulation system 400 and the inkjet head 500. In an embodiment, for example, the uniform circulation system 700 may include a by-pass line 710 and a flow rate regulator 720.

The by-pass line 710 may remove the bubbles BUB generated in the supply circulation system 400 and the inkjet head 500. The by-pass line 710 may connect the supply circulation system 400 with the discharge circulation system 600.

In one embodiment, the by-pass line 710 may include a first by-pass line 711, a second by-pass line 712, a third by-pass line 713 and a fourth by-pass line 714.

The first by-pass line 711 may connect the fourth supply flow path 424 and the first discharge flow path 611 to each other. The second by-pass line 712 may connect the fifth supply flow path 425 and the second discharge flow path 612 to each other. The third by-pass line 713 may connect the sixth supply flow path 426 and the third discharge flow path 613 to each other. The fourth by-pass line 714 may connect the seventh supply flow path 427 and the fourth discharge flow path 614 to each other.

The flow rate regulator 720 may control distribution of the flow rate for each inkjet head 500. In one embodiment, the flow rate regulator 720 may be disposed at one point of each by-pass line 710 connected to each inkjet head 500.

In some embodiments, at least one flow rate regulator 720 may be disposed at each of the inkjet heads 500. In an embodiment, for example, the number of the flow rate regulators 720 may be the same as the number of the inkjet heads 500, but is not limited thereto.

In some embodiments, the flow rate regulator 720 may be a switching device capable of quantitatively regulating the flow rate of the ink I. In an embodiment, for example, the flow rate regulator 720 may quantitatively regulate the flow rate of the ink I up to 0% to 100%. The flow rate regulator 720 may regulate the flow rate of the ink I to 0% or 100% to perform an on/off function, and may regulate the flow rate of the ink I to allow the ink I to pass through the flow path at the amount less than 100%.

In one embodiment, the flow rate regulator 720 may include a first flow rate regulator 721, a second flow rate regulator 722, a third flow rate regulator 723 and a fourth flow rate regulator 724.

The first flow rate regulator 721 may be disposed in the first by-pass line 711. The second flow rate regulator 722 may be disposed in the second by-pass line 712. The third flow rate regulator 723 may be disposed in the third by-pass line 713. The fourth flow rate regulator 724 may be disposed in the fourth by-pass line 714.

Hereinafter, a circulation structure and an operation method of the inkjet printing apparatus 10, which includes the by-pass line 710 and the flow rate regulator 720, will be described.

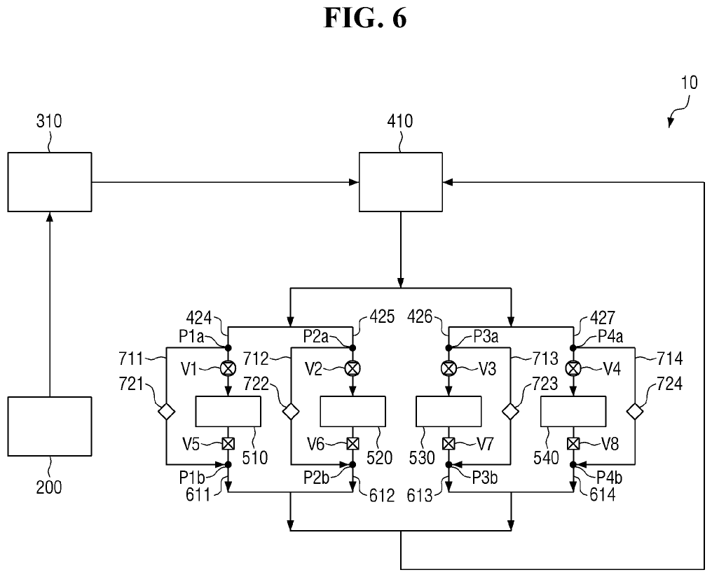

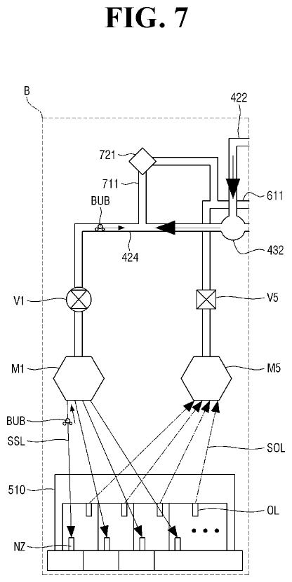

FIG. 6 is a block diagram illustrating a circulation structure of an inkjet printing apparatus according to one embodiment. FIG. 7 is an enlarged view illustrating an area B of FIG. 5.

Referring to FIGS. 6 and 7 in addition to FIG. 5, as shown in FIG. 6, the first by-pass line 711 may connect a first point P1a on the fourth supply flow path 424 with a fifth point P1b on the first discharge flow path 611. The second by-pass line 712 may connect a second point P2a on the fifth supply flow path 425 with a sixth point P2b on the second discharge flow path 612. The third by-pass line 713 may connect a third point P3a on the sixth supply flow path 426 with a seventh point P3b on the third discharge flow path 613. The fourth by-pass line 714 may connect a fourth point P4a on the seventh supply flow path 427 with an eighth point P4b on the fourth discharge flow path 614.

In the drawing, the first to fourth points P1a, P2a, P3a and P4a are shown as being disposed between the supply valves V1, V2, V3 and V4 and the supply storage device 410 based on a circulation path of the ink I, but are not limited thereto. In another embodiment, the first to fourth points P1a, P2a, P3a and P4a may be disposed between the supply valves V1, V2, V3 and V4 and the supply manifolds M1, M2, M3 and M4 based on the circulation path of the ink I.

Also, in the drawing, the fifth to eighth points P1b, P2b, P3b and P4b are shown as being disposed between the discharge valves V5, V6, V7 and V8 and the supply storage device 410 based on the circulation path of the ink I, but are not limited thereto. In another embodiment, the fifth to eighth points P1b, P2b, P3b and P4b may be disposed between the discharge valves V5, V6, V7 and V8 and the discharge manifolds M5, M6, M7 and M8 based on the circulation path of the ink I.

When the ink I is initially injected in a state that the inside of the path of the ink I of the inkjet printing apparatus 10 is empty, the bubbles BUB may be formed in the supply circulation system 400. When ink I is discharged through the inkjet head 500 in a state that the bubbles BUB are formed, a non-discharge nozzle NZ may be generated or non-uniform discharge may occur. The inkjet printing apparatus 10 according to the present embodiment may include a by-pass line 710 connecting the supply circulation system 400 with the discharge circulation system 600, thereby removing the bubbles BUB formed in the supply circulation system 400.

For example, as shown in FIG. 7, when the bubbles BUB are generated in the first inkjet head 510 or generated in a sub-supply flow path SSL positioned between the first manifold M1 and the first inkjet head 510, the bubbles BUB may move toward the fourth supply flow path 424 that is in a direction (e.g., the third direction DR3) opposite to the gravity direction due to a difference in density from the ink I. The bubbles BUB positioned in the fourth supply flow path 424 may move to the first discharge flow path 611 along the first by-pass line 711. The bubbles BUB_moved to the first discharge flow path 611 may be removed by being discharged to the supply storage device 410. Therefore, non-discharge and non-uniform discharge of the ink I due to the bubbles BUB may be effectively minimized. In addition, since a separate bubble removing device is not required, costs may be reduced.

FIG. 5 illustrates that the supply circulation system 400 includes one second pump P2. However, the supply circulation system 400 according to embodiments is not limited thereto. In another embodiment, the supply circulation system 400 may include a plurality of second pumps P2. For example, the plurality of second pumps P2 may be disposed in some of the first to seventh supply flow paths 421 to 427, respectively, so that the plurality of second pumps P2 may provide driving forces to move the ink along the some of the first to seventh supply flow paths 421 to 427.

FIG. 5 illustrates that the supply circulation system 400 includes one supply storage device 410. However, the supply circulation system 400 according to embodiments is not limited thereto. In another embodiment, the supply circulation system 400 may include a plurality of supply storage device 410.

In the inkjet printing apparatus 10 according to the present embodiment, the number of the supply storage devices 410 and the number of the second pumps P2 may each be smaller than the number of the inkjet heads 500. In an embodiment, for example, a plurality of inkjet heads 500 may be connected to one supply storage device 410 and one second pump P2. Therefore, a spatial limitation for installing the inkjet printing apparatus 10 may be resolved as compared with that one supply storage device 410 and one second pump P2 are each provided for only one inkjet head 500. Accordingly, in the present embodiment, the number of the supply storage devices 410 and the number of the second pumps P2 may be reduced, whereby economic efficiency may be increased.

Each inkjet head 500 connected to one supply storage device 410 and one second pump P2 may receive its respective hydraulic pressure depending on the design structure of the inkjet printing apparatus 10 such as length, angle and height of the supply flow path 420. That is, each inkjet head 500 connected to one supply storage device 410 and one second pump P2 may have distribution of a flow rate according to a hydraulic pressure different for each head. Therefore, the respective inkjet heads 500 may be desirable to regulate their flow rates differently from each other. The inkjet printing apparatus 10 according to the present embodiment may include a flow rate regulator 720 connected to each inkjet head 500, thereby regulating a flow rate for each inkjet head 500.

For example, for design reasons, a lower hydraulic pressure may be applied to the first inkjet head 510 and a higher hydraulic pressure may be applied to the second inkjet head 520. At this time, a switching rate of the first flow rate regulator 721 connected to the first by-pass line 711 may be lowered, and a switching rate of the second flow rate regulator 722 connected to the second by-pass line 712 may be increased. In this case, the switching rate means a ratio of the degree of opening to the degree of closing of the flow rate regulator. When the switching rate of the first flow rate regulator 721 is lowered, the amount of the ink I moving to the discharge circulation system 600 through the first by-pass line 711 is reduced, so that the hydraulic pressure of the first inkjet head 510 is relatively increased, and when the switching rate of the second flow rate regulator 722 is increased, the amount of the ink I moving to the discharge circulation system 600 through the second by-pass line 712 is increased, whereby the hydraulic pressure of the second inkjet head 520 may be relatively lowered. Therefore the first inkjet head 510 and the second inkjet head 520 may be controlled to have the same hydraulic pressure and the same flow rate.

Hereinafter, other embodiments of the inkjet printing apparatus according to one embodiment will be described. In the following embodiments, the same reference numerals will be given to the same elements as those in the previous embodiment, and a redundant description will be omitted or simplified and the following description will be based on differences from the previous embodiment.

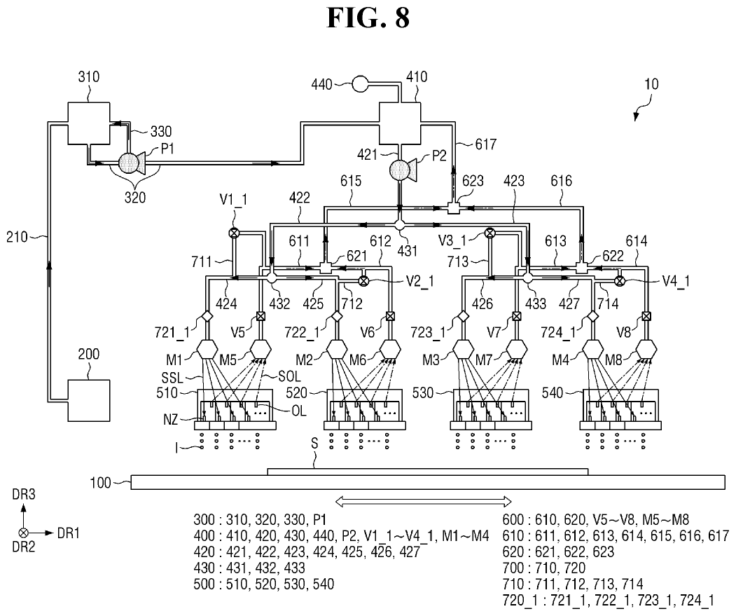

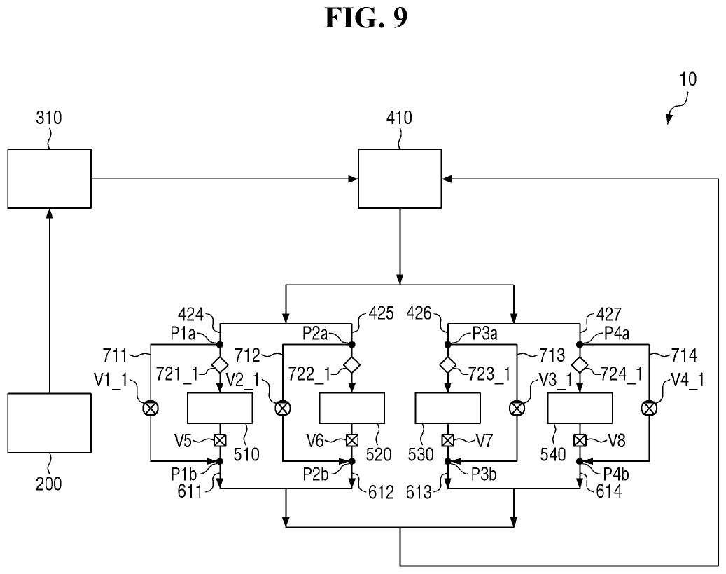

FIG. 8 is a cross-sectional view illustrating an inkjet printing apparatus according to another embodiment. FIG. 9 is a block diagram illustrating a circulation structure of an inkjet printing apparatus according to another embodiment.

Referring to FIGS. 8 and 9, the inkjet printing apparatus 10 according to the present embodiment differs from the inkjet printing apparatus 10 according to one embodiment described with reference to FIG. 5 in that positions of supply valves V1_1, V2_1, V3_1 and V4_1 and a flow rate regulator 720_1 are different from those of FIG. 5.

In more detail, the plurality of supply valves V1_1, V2_1, V3_1 and V4_1 may adjust whether the ink I flows in the by-pass line 710. In an embodiment, for example, when the plurality of supply valves V1_1, V2_1, V3_1 and V4_1 are opened, the ink I may pass through the by-pass line 710, and when the plurality of supply valves V1_1, V2_1, V3_1 and V4_1 are closed, the ink I may not pass through the by-pass line 710.

In one embodiment, the plurality of supply valves V1_1, V2_1, V3_1 and V4_1 may include a first valve V1_1, a second valve V2_1, a third valve V3_1 and a fourth valve V4_1. The first valve V1_1 may be disposed in the first by-pass line 711 to adjust whether the ink I flows in the first by-pass line 711. The second valve V2_1 may be disposed in the second by-pass line 712 to adjust whether the ink I flows in the second by-pass line 712. The third valve V3_1 may be disposed in the third by-pass line 713 to adjust whether the ink I flows in the third by-pass line 713. The fourth valve V4_1 may be disposed in the fourth by-pass line 714 to adjust whether the ink I flows in the fourth by-pass line 714.

The flow rate regulator 720_1 may be disposed at one point of each supply flow path 420 connected to each inkjet head 500. In an embodiment, for example, a first flow rate regulator 721_1 may be disposed in the fourth supply flow path 424, a second flow rate regulator 722_1 may be disposed in the fifth supply flow path 425, a third flow rate regulator 723_1 may be disposed in the sixth supply flow path 426, and a fourth flow rate regulator 724_1 may be disposed in the seventh supply flow path 427.

While an inkjet printing process is being performed, the flow rate regulator 720_1 connected to each inkjet head 500 may be adjusted to control distribution of a flow rate. In an embodiment, for example, a flow rate of the first inkjet head 510 may be adjusted by the first flow rate regulator 721_1 disposed in the fourth supply flow path 424 connected to the first inkjet head 510, a flow rate of the second inkjet head 520 may be regulated by the second flow rate regulator 722_1 disposed in the fifth supply flow path 425 connected to the second inkjet head 520, a flow rate of the third inkjet head 530 may be regulated by the third flow rate regulator 723_1 disposed in the sixth supply flow path 426 connected to the third inkjet head 530, and a flow rate of the fourth inkjet head 540 may be regulated by the fourth flow rate regulator 724_1 disposed in the seventh supply flow path 427 connected to the fourth inkjet head 540.

Meanwhile, while the inkjet printing process is being performed, by-pass line circulation and inkjet head circulation may be performed by a separate process. In an embodiment, for example, while ink discharge is being performed, the supply valves V1_1, V2_1, V3_1 and V4_1 may be maintained at an off-state. In this case, the ink I may circulate only the supply circulation system 400, the inkjet head 500 and the discharge circulation system 600 without moving along the by-pass line 710.

On the other hand, while ink discharge such as replacing the target substrate S or aligning the target substrate S with the inkjet head 500 is not being performed, the supply valves V1_1, V2_1, V3_1 and V4_1 may be maintained at an on-state. In this case, the ink I may move along the by-pass line 710, and the bubbles BUB formed in the supply circulation system 400 and the inkjet head 500 may be escaped through the by-pass line 710.

In the inkjet printing apparatus 10 according to the present embodiment as described above, by-pass line circulation and inkjet head circulation may be separately performed, whereby hydraulic pressure loss due to additional by-pass line 710 may be reduced. In addition, since the by-pass line circulation for removing the bubbles BUB is performed while ink discharge is not being performed in the inkjet printing process, process efficiency may be improved.

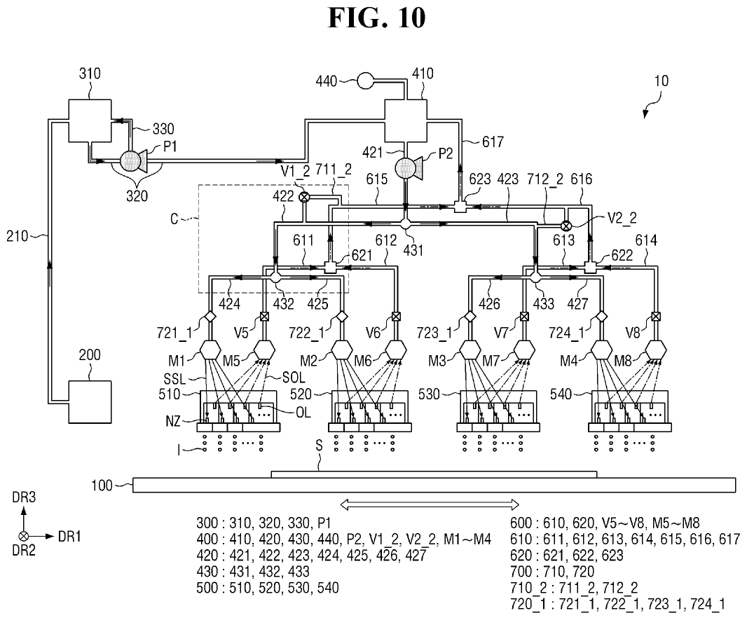

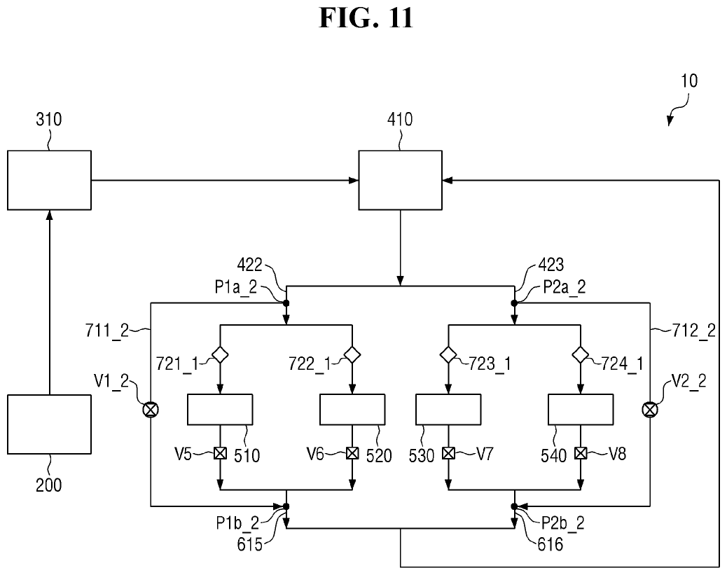

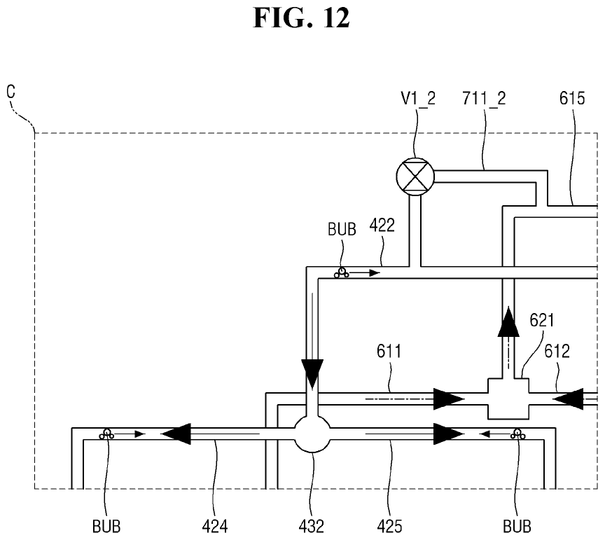

FIG. 10 is a cross-sectional view illustrating an inkjet printing apparatus according to still another embodiment. FIG. 11 is a block diagram illustrating a circulation structure of an inkjet printing apparatus according to still another embodiment. FIG. 12 is an enlarged view illustrating an area ‘C’ of FIG. 10.

Referring to FIGS. 10 to 12, the inkjet printing apparatus 10 according to the present embodiment differs from the inkjet printing apparatus 10 according to another embodiment described with reference to FIG. 8 in that a position of a by-pass line 710_2 is different from that of FIG. 8.

In more detail, a plurality of supply valves V1_2 and V2_2 may adjust whether the ink I flows in the by-pass line 710_2. In an embodiment, for example, when the plurality of supply valves V1_2 and V2_2 are opened, the ink I may pass through the by-pass line 710_2, and when the plurality of supply valves V1_2 and V2_2 are closed, the ink I may not pass through the by-pass line 710_2.

In one embodiment, the plurality of supply valves V1_2 and V2_2 may include a first valve V1_2 and a second valve V2_2. The first valve V1_2 may be disposed in a first by-pass line 711_2 to adjust whether the ink I flows in the first by-pass line 711_2. The second valve V2_2 may be disposed in a second by-pass line 712_1 to adjust whether the ink I flows in the second by-pass line 712_2.

The by-pass line 710_2 may include a first by-pass line 711_2 and a second by-pass line 712_2.

The first by-pass line 711_2 may connect the second supply flow path 422 and the fifth discharge flow path 615 to each other. The second by-pass line 712_2 may connect the third supply flow path 423 and the sixth discharge flow path 616 to each other.

As shown in FIG. 11, the first by-pass line 711_2 may connect a ninth point P1a-2 on the second supply flow path 422 with an eleventh point P1b_2 on the fifth discharge flow path 615. The second by-pass line 712_2 may connect a tenth point P2a_2 on the third supply flow path 423 with a twelfth point P2b_2 on the sixth discharge flow path 616.

In the inkjet printing apparatus 10 according to the present embodiment, when bubbles BUB are generated in the supply circulation system 400 such as the fourth supply flow path 424 and the fifth supply flow path 425, the bubbles BUB may move toward the second supply flow path 422 that is in a direction (e.g., the third direction DR3) opposite to the gravity direction due to a difference in density from the ink I. When the first valve V1_2 is maintained at an on-state, the bubbles BUB positioned in the second supply flow path 422 may move toward the first by-pass line 711_2. The bubbles BUB positioned in the second supply flow path 422 may move to the fifth discharge flow path 615 along the first by-pass line 711_2. The bubbles BUB moved to the fifth discharge flow path 615 may be removed by being discharged to the supply storage device 410. Therefore, non-discharge and non-uniform discharge of the ink I due to the bubbles BUB may be effectively minimized. In addition, since a separate bubble removing device is not required, costs may be reduced.

In concluding the detailed description, those skilled in the art will appreciate that many variations and modifications can be made to the preferred embodiments without substantially departing from the principles of the present disclosure. Therefore, the disclosed preferred embodiments of the invention are used in a generic and descriptive sense only and not for purposes of limitation.

What is claimed is:

1. An inkjet printing apparatus comprising:
a plurality of inkjet heads configured to discharge ink;
a supply storage device configured to supply the ink to the plurality of inkjet heads;
a plurality of supply flow paths configured to move the ink from the supply storage device to the plurality of inkjet heads;
a plurality of discharge flow paths configured to move the ink from the plurality of inkjet heads to the supply storage device; and
a plurality of by-pass lines directly connecting the plurality of supply flow paths with the plurality of discharge flow paths.

2. The inkjet printing apparatus of claim 1, further comprising a plurality of flow rate regulators disposed in the plurality of by-pass lines,
wherein the plurality of flow rate regulators are configured to regulate a flow rate of the ink moving along the plurality of by-pass lines.

3. The inkjet printing apparatus of claim 2, further comprising a plurality of valves disposed in the plurality of supply flow paths,
wherein the plurality of valves are configured to adjust a flow of the ink moving along the plurality of supply flow paths.

4. The inkjet printing apparatus of claim 1, further comprising a plurality of flow rate regulators disposed in the plurality of supply flow paths,
wherein the plurality of flow rate regulators are configured to regulate a flow rate of the ink moving along the plurality of supply flow paths.

5. The inkjet printing apparatus of claim 4, further comprising a plurality of valves disposed in the plurality of by-pass lines,
wherein the plurality of valves are configured to control whether the ink flows along the plurality of by-pass lines.

6. The inkjet printing apparatus of claim 1, wherein the plurality of supply flow paths include first to fifth supply flow paths,
the first supply flow path is connected to the supply storage device and diverged into the second supply flow path and the third supply flow path at a first divergence point,
the second supply flow path is connected to the first divergence point and a second divergence point and diverged into the fourth supply flow path and the fifth supply flow path at the second divergence point, and
the fourth and fifth supply flow paths are each connected to one of the plurality of inkjet heads.

7. The inkjet printing apparatus of claim 6, wherein the plurality of discharge flow paths include first to fifth discharge flow paths,
the first discharge flow path and the second discharge flow path are each connected to one of the plurality of inkjet heads and are merged into the third discharge flow path at a first merging point,
the third discharge flow path is connected to the first merging point and a second merging point, and
the third discharge flow path and the fourth discharge flow path are merged into the fifth discharge flow path at the second merging point, and
the fifth discharge flow path is connected to the supply storage device.

8. The inkjet printing apparatus of claim 7, wherein the plurality of by-pass lines include at least one of a first by-pass line or a second by-pass line,
the first by-pass line connects the fourth supply flow path with the first discharge flow path, and
the second by-pass line connects the fifth supply flow path with the second discharge flow path.

9. The inkjet printing apparatus of claim 7, wherein the plurality of by-pass lines include a third by-pass line, and
the third by-pass line connects the second supply flow path with the third discharge flow path.

10. The inkjet printing apparatus of claim 1, further comprising a pump disposed in the plurality of supply flow paths,
wherein the pump is configured to provide a driving force so that the ink moves along the plurality of supply flow paths.

11. The inkjet printing apparatus of claim 10, wherein the supply storage device is provided as one or more, the pump is provided as one or more, a total number of the one or more supply storage devices and a total number of the one or more pumps are each smaller than a total number of the plurality of inkjet heads.

12. The inkjet printing apparatus of claim 11, wherein the plurality of inkjet heads are connected to one supply storage device and one pump.

13. The inkjet printing apparatus of claim 1, further comprising a buffer storage device configured to supply the ink to the supply storage device.

14. The inkjet printing apparatus of claim 13, further comprising:
a first buffer flow path configured to move the ink from the buffer storage device to the supply storage device; and
a second buffer flow path configured to move the ink from the first buffer flow path to the buffer storage device.

15. The inkjet printing apparatus of claim 1, further comprising a plurality of manifolds disposed between the plurality of supply flow paths and the plurality of inkjet heads,
wherein the plurality of manifolds are configured to supply the ink to a plurality of nozzles included in the plurality of inkjet heads.

16. An inkjet printing apparatus comprising:
first and second inkjet heads configured to discharge ink;
a supply storage device configured to supply the ink to the first and second inkjet heads;
first and second supply flow paths configured to move the ink from the supply storage device to the first and second inkjet heads, respectively;
first and second discharge flow paths configured to move the ink from the first and second inkjet heads to the supply storage device, respectively; and
a first by-pass line connecting the first supply flow path with the first discharge flow path and a second by-pass line connecting the second supply flow path with the second discharge flow path.

17. The inkjet printing apparatus of claim 16, further comprising first and second flow rate regulators disposed in the first and second by-pass lines, respectively,
wherein the first and second flow rate regulators are configured to regulate flow rates of the ink moving along the first and second by-pass lines, respectively.

18. The inkjet printing apparatus of claim 16, further comprising first and second flow rate regulators disposed in the first and second supply flow paths, respectively,
wherein the first and second flow rate regulators are configured to regulate flow rates of the ink moving along the first and second supply flow paths, respectively.

19. The inkjet printing apparatus of claim 16, further comprising first and second pumps disposed in the first and second supply flow paths, respectively,
wherein the first and second pumps are configured to provide a driving force so that the ink move along the first and second supply flow paths.

20. The inkjet printing apparatus of claim 19, wherein the supply storage device is provided as one or more, the pump is provided as one or more, a total number of the one or more supply storage devices and a total number of the one or more pumps are each smaller than a total number of the inkjet heads.
